(19) United States
(12) Patent Application Publication
(10) Pub. No.: US 2025/0110780 A1
(43) Pub. Date: Apr. 3, 2025

(54) SYSTEM AND METHOD FOR MULTI-CLUSTER ORCHESTRATION

(71) Applicant: Elotl, Inc., San Francisco, CA (US)

(72) Inventors: Madhuri YECHURI, San Francisco, CA (US); Pawel BOJANOWSKI, Warsaw (PL); Anne Marie HOLLER, Los Altos, CA (US); Selvi KADIRVEL, San Jose, CA (US); Maciej URBANSKI, Warsaw (PL); Jan BARANIEWSKI, Warsaw (PL); Henry PRECHEUR, Vancouver (CA); Chi SU, Sunnyvale, CA (US)

(73) Assignee: Elotl, Inc., San Francisco, CA (US)

(21) Appl. No.: 18/906,116

(22) Filed: Oct. 3, 2024

Related U.S. Application Data
(60) Provisional application No. 63/587,455, filed on Oct. 3, 2023.

(51) Int. Cl. G06F 9/50; G06F 9/54

(52) U.S. Cl. CPC G06F 9/5005; G06F 9/54; G06F 2209/505

(57) ABSTRACT

Execution of computing workloads by a fleet of multiple Kubernetes clusters in a distributed computing environment in managed by determining on which of a plurality of managed clusters to place the workloads, by tracking and matching resource needs of the workloads with cluster resource capacities and availability. Common workloads related to multi-tenancy across subsets of the fleet of clusters can be duplicated, thereby enabling standardization of clusters and prevention of redundant manifests across software repositories. Workloads may be placed according to different policies, including placing them on an ordered set of target clusters and, according to the ordered set, prioritizing the workloads in the ordered set, or on statically, pre-determined clusters. Clusters may also be cloned and, on demand, new clusters may be brought up and idle clusters may be shut down. The start of workloads may also be triggered from a failed cluster to a different functional cluster.

### RELATED APPLICATIONS

This application claims priority of U.S. Provisional Patent Application No. 63/587,455, which was filed on 3 Oct. 2023.

### TECHNICAL FIELD

This invention relates to management of application execution over multiple clusters in a distributed computing environment.

### BACKGROUND OF THE INVENTION

Distributed software applications are increasingly being packaged and deployed via Linux containers because of the advantages this provides. These advantages include portability across different infrastructure environments, application scalability, faster development through agile and devops tools, lighter-weight distribution and ease-of-management, among others. In the context of containerized applications, Kubernetes has emerged as the de-facto standard for orchestration of containerized applications. The organizations and “community” behind Kubernetes themselves describe Kubernetes thus: “Kubernetes, also known as K8s, is an open source system for automating deployment, scaling, and management of containerized applications . . . . It groups containers that make up an application into logical units for easy management and discovery” (see www.kubernetes.io). As described in Wikipedia, “Kubernetes assembles one or more computers, either virtual machines or bare metal, into a cluster which can run workloads in containers. It works with various container runtimes, . . . . Its suitability for running and managing workloads of all sizes and styles has led to its widespread adoption in clouds and data centers. There are multiple distributions of this platform—from independent software vendors (ISVs) as well as hosted-on-cloud offerings from all the major public cloud vendors” (see https://en.wikipedia.org/wiki/Kubernetes).

As Kubernetes “cluster” is a group of computing nodes, or worker machines, that run containerized applications. Containerization is in turn a software deployment and runtime process that bundles an application's code with all the files and libraries it needs to run on any infrastructure.

Once users adopt a Kubernetes cluster for running their applications, the need for multiple clusters arises for a variety of reasons: geographical distribution of workloads, resource isolation between tenants or teams, isolation between different stages of software life-cycle (e.g. development, testing, staging and production), ensuring services are in different fault-domains, etc. Currently, managing and orchestrating applications across these multiple clusters is challenging for a number of reasons:
Workloads and the mapping of the target clusters on which they are to be run needs to be maintained and managed by cluster administrators. This can get unwieldy when the number of clusters is more than a handful.
When workload properties such as resource consumption changes due to incoming service load changes, these workloads need to be manually migrated to a more suitable cluster.
Cluster administrators need to provision clusters for specific purposes every time the need arises.

Managing multiple Kubernetes clusters is possible via various public cloud providers' Kubernetes management consoles, such as Amazon's Elastic Kubernetes Service, Google's Google Kubernetes Engine and Microsoft's Azure Kubernetes Service (AKS). However these solutions do not provide a single-point of access that Kubernetes workloads can be targeted to and help schedule these workloads flexibly across multiple-clusters and multiple cloud providers. Each of these Kubernetes solutions allow for management of workloads and clusters within only the specific cloud provider.

Scheduling workloads across clusters is possible via the projects Open-Cluster-Management (https://open-cluster-management.io/), Karmada (https://karmada.io/), KCP (https://www.kcp.io/) and Liqo (https://liqo.io/). However these projects do not provide an infrastructure management dimension that allows on-demand cluster provisioning triggered by resource needs of incoming workloads. Furthermore they do not provide the automation of high-availability and disaster-recovery actions, which is a critical part of application and service operation in enterprises.

### BRIEF DESCRIPTION OF THE DRAWINGS

FIG. 1 illustrates the main components of the system architecture according to one embodiment of the invention.

FIG. 2 illustrates various controllers within a scheduler component.

FIG. 3 illustrates various controllers that are run by an agent.

### DETAILED DESCRIPTION

For convenience, embodiments of the invention described here are referred to collectively as “Nova”, and are provided for multi-cluster orchestration. The particular features of embodiments of Nova are described below in greater detail, but are summarized here in broad terms:

In the context of Kubernetes, Nova's Scheduler, via “Capacity-based Scheduling”, determines the appropriate managed clusters to place workloads on by keeping track of and matching the resource needs of workloads with the resource capacities and availability of all the clusters in a fleet. This has the advantage that it allows users to utilize infrastructure across different cloud providers and on-premises Kubernetes clusters easily.

Nova's Scheduler, via “Spread Scheduling”, can duplicate common Kubernetes workloads related to multi-tenancy (e.g. namespaces), security (e.g., secrets), etc., across subsets of fleets of workload clusters, which allows for standardization of clusters and prevents redundant manifests across software repositories.

Nova's Scheduler, via “Fill-and-spill scheduling”, can also place workloads on an ordered set of target clusters, allowing certain clusters to be prioritized over others, thus enabling infrastructure usage in a cost-efficient manner.

Using “annotation-based scheduling”, Nova's Scheduler can also place workloads on statically, pre-determined clusters, which results in operational ease-of-use.

Using a Just-in-Time (JIT) cluster feature, Nova can clone and bring up new clusters on-demand as well as shut down clusters when they are idle. This has the potential to reduce infrastructure costs significantly when compared to conventional always-on peak provisioned clusters.

By the mechanism of “Automation of Disaster Recovery”, Nova can trigger the start of workloads from a failed cluster to a different functional cluster (in a different geographical region or availability zone), thereby reducing Mean-Time-To-Recovery (MTTR) of cluster level workload failures (e.g. database primary failures).

Nova solves problems, including those mentioned above, that arise in deploying and running workloads across multiple compute clusters, using primarily these mechanisms:
Annotation-based scheduling: Nova enables capturing target clusters for different workloads through the simple addition of annotations to a workload manifest.
Policy-based scheduling: Nova enables capturing target clusters for different workloads via a flexible mechanism called a “Schedule policy” This schedule policy allows users to map different subsets of their Kubernetes resources to different groups of clusters.
Dynamic re-scheduling: When an application resource needs to change, workload placement decisions are re-evaluated by Nova and updated scheduling decisions are put into effect automatically.
Workload migration: Workloads running on one cluster can be easily migrated to another cluster via modifying annotations in the workload or by modifying the schedule-policy.
Capacity-based scheduling: Nova has the capability to track available resource capacity on all its managed clusters and thereby place workloads on an appropriate cluster that has sufficient capacity.
Spread-scheduling: Nova provides the capability for a single workload unit in Kubernetes to be spread across multiple clusters equally or via a percentage specification
Just-in-time cluster provisioning: When workloads arrive at the Nova control plane, if the capacity available on the existing clusters is insufficient then Nova can automatically provision a new cluster to run this workload
HA/DR (High Availability/Disaster Recovery) automation for workloads: After Nova schedules workloads on its managed clusters, Nova will automatically handle application-level and cluster-level failures during operation. Failure handling is captured in multiple ways, which include 1) a sequence of Kubernetes workload modifications, 2) rescheduling of workloads to a new backup cluster or a Just-in-Time compute cluster, as well as 3) a user-specified Kubernetes job that can interact with other cloud resources for failover and remediation tasks. Nova solves the automation of HA/DR goals for stateful workloads such as databases.

In addition to these functionalities, Nova also has advantages when it comes to implementing these features:

1. A Nova control plane exposes a Kubernetes-native API for workloads, thereby allowing users and cluster administrators to easily transition from single-cluster to multi-cluster environments. Nova may use a Kubernetes native component—the API-server (see https://kubernetes.io/docs/reference/command-line-tools-reference/kube-apiserver/)—augmented with a nova-scheduler component to implement this. The API may thus be 100% conformant with the native Kubernetes API, so any resources that can be scheduled on a single cluster can automatically also be scheduled through Nova's control plane to a fleet of workload clusters.

2. This implementation choice of exposing the native Kubernetes API is also advantageous since it allows for Nova to be seamlessly integrated with Continuous deployment Git-Ops-based tools, which are becoming increasingly important in the enterprise.

3. Nova requires the user to learn about only one new custom resource, namely, the “Schedule Policy”. This minimizes the cognitive load on users in having to learn new concepts to transition from single to multiple clusters for their infrastructure platform.

Nova's powerful schedule policies may be extended to:
a. Cost-based scheduling: This will allow cluster operators to schedule their workloads to the most cost-efficient target clusters.
b. Latency-aware scheduling: This will allow cluster operators to schedule their workloads taking into consideration applications and services current latency requirements to achieve end-user's quality-of-service needs.

Nova builds on several concepts:

### Annotation-Based Scheduling

In Annotation-based scheduling, Kubernetes workloads are scheduled to run on any one of the workload clusters managed by the Nova control plane simply by adding an annotation to the workload manifest. An “annotation” refers to meta-data added to a Kubernetes manifest file. In the example manifest for Kubernetes deployment (see pseudocode Snippet 1), the annotation is in italics and marked in bold letters.

Various examples of how different aspects of the invention can be implemented are described below both in words and in code (“Snippets”) that those familiar with programming for the Kubernetes platform will readily understand. In particular, the code below used to illustrate aspects of the invention is expressed in the YAML programming language, which is a human-readable data serialization language that is commonly, but not exclusively, used for configuration files and in applications where data are being stored or transmitted.

Snippet 1: Sample Kubernetes Manifest with Annotation

```
apiVersion: apps/v1
kind: Deployment
metadata:
    name: nginx
    labels:
        app: nginx
    annotations:
        nova.elotl.co/cluster: my-workload-1
spec:
    replicas: 2
    selector:
        matchLabels:
            app: nginx
  template:
      metadata:
          labels:
            app: nginx
    spec:
        containers:
              - name: nginx
              image: nginx:1.14.2
              ports:
            - containerPort: 80
```

This annotation indicates to Nova that this Kubernetes resource, namely a deployment needs to be placed on a workload cluster named “my-workload-1”. A Kubenetes deployment is a known concept, which “manages a set of Pods to run an application workload, usually one that doesn't maintain state. A Deployment provides declarative updates for Pods and ReplicaSets. You describe a desired state in a Deployment, and the Deployment Controller changes the actual state to the desired state at a controlled rate. You can define Deployments to create new ReplicaSets, or to remove existing Deployments and adopt all their resources with new Deployments”. (see https://kubernetes.io/docs/concepts/workloads/controllers/deployment/)

### Policy-Based Scheduling

In policy-based scheduling, users define a custom Kubernetes resource called the Schedule Policy to specify where Kubernetes resources will be scheduled. This Schedule Policy enables the user to specify the following aspects about workload placement:
Which Kubernetes resources are included to be scheduled by this policy, and
Which subset of workload clusters need to be considered by this policy

Each of these two aspects can be specified in a number of flexible ways, some of which will be described below.

Kubernetes resources to be matched by a Schedule Policy can be selected using labels or by specifying a namespace, or a combination of both. Workload clusters that will be considered by a Schedule policy can be specified as a list with cluster names or via cluster labels. Cluster labels allow users to group clusters. For example, all dev clusters could be considered for certain workloads by adding an env: dev label to all these workload clusters.

Nova implements Schedule Policies as a Custom Resource, which allows users to extend the Kubernetes API to domain-specific and/or user-defined resources. “Custom resources are extensions of the Kubernetes API. This page discusses when to add a custom resource to your Kubernetes cluster and when to use a standalone service. It describes the two methods for adding custom resources and how to choose between them . . . . A resource is an endpoint in the Kubernetes API that stores a collection of API objects of a certain kind; for example, the built-in pods resource contains a collection of Pod objects. A custom resource is an extension of the Kubernetes API that is not necessarily available in a default Kubernetes installation. It represents a customization of a particular Kubernetes installation” (https://kubernetes.io/docs/concepts/extend-kubernetes/api-extension/custom-resources/in Kubernetes).

### EXAMPLE

Given below is a sample SchedulePolicy (Snippet 2). This Schedule policy (implemented according to the bolded and italicized code) matches all Kubernetes resources with a label named, for example, “app: nginx” and within the namespace, “kubernetes.io/metadata.name: nginx”. A match here refers to the fact that this policy will govern where all of the corresponding nginx resources will be placed.

### Snippet 2: Sample Schedule Policy.

```
apiVersion: policy.elotl.co/v1alpha1
kind: SchedulePolicy
metadata:
  name: demo-policy
spec:
    namespaceSelector:
      matchLabels:
          kubernetes.io/metadata.name: nginx
  groupBy:
      labelKey: color
  resourceSelectors:
      labelSelectors:
        - matchLabels:
        app: nginx
```

### Workload Migration

Workload migration in Nova refers to moving Kubernetes resources from one workload cluster to another. This migration can be initiated by the user in two different ways: 1) by editing the destination cluster specified in a workload's annotation and 2) by editing the eligible set of clusters specified in the Schedule Policy.

In addition to these user-initiated workload migrations, Nova can also automatically choose a different cluster for certain workloads when the current resources needed for a workload exceed a cluster's capacity.

Example—Consider an example of user-initiated workload migration via policy-based scheduling. A user wanting workload group “my-store” to be scheduled on a team's dev cluster would have a schedule policy with the cluster-selector set to “team-dev-cluster” as illustrated in the following Snippet 3.

### Snippet 3. Schedule Policy Illustrating Source Cluster of a Workload Migration

```
apiVersion: policy.elotl.co/v1alpha1
kind: SchedulePolicy
metadata:
  name: demo-policy
spec:
...
clusterSelector:
  matchExpressions:
    - key: kubernetes.io/metadata.name
    operator: In
    Values:
    - team-dev-cluster
```

When the team would like its workload migrated to the team's staging cluster, the policy manifest may be edited to replace the cluster name as shown in Snippet 4.

Snippet 4. Schedule policy illustrating destination cluster of a workload migration

```
apiVersion: policy.elotl.co/v1alpha1
kind: SchedulePolicy
metadata:
  name: demo-policy
spec:
...
clusterSelector:
  matchExpressions:
    - key: kubernetes.io/metadata.name
    operator: In
    Values:
    - team-staging-cluster
```

### Capacity-Based Scheduling

Using the policy-based scheduling mechanism, Nova provides the capability to schedule a workload based on resource availability in a workload cluster. This means that a single Kubernetes resource or a group of Kubernetes resources will be placed on a target cluster that has sufficient capacity to host it. A schedule policy can specify capacity-based scheduling by leaving out the usual clusterSelector field as shown in the example Snippet 5 below. This sample policy also shows how a group of Kubernetes objects are grouped together using a color label.

Snippet 5: Policy for capacity-based group-scheduling

```
apiVersion: policy.elotl.co/v1alpha1
kind: SchedulePolicy
metadata:
    name: demo-policy
spec:
    namespaceSelector:
      matchLabels:
      kubernetes.io/metadata.name: nginx-group-demo
  groupBy:
      labelKey: color
  resourceSelectors:
      labelSelectors:
      - matchLabels:
      nginxGroupScheduleDemo: “yes”
```

### Spread Scheduling

Spread scheduling is a scheduling strategy that allows users to deploy a Kubernetes resource across many workload clusters. This strategy has two different modes of operation:

### “Divide and Duplicate”

Duplicate Mode: In the Duplicate mode of operation, non-workload Kubernetes objects like Namespaces, Service accounts, Services, etc., as well as workload objects like Deployments, StatefulSets and DaemonSets, are duplicated and scheduled to all selected workload clusters in a matching Schedule Policy.

Assume for example there is a Namespace, ServiceAccount and a Deployment (of 10 replicas) as part of an application that a user wants to duplicate across three workload clusters. Each selected workload cluster will contain the same Namespace, ServiceAccount, and a Deployment of 10 replicas.

Divide Mode: The Divide mode of operation applies to workload objects like Deployments and StatefulSets that include a replica count as part of their definition. This mode enables replicas to be divided across selected workload clusters based on a user-defined percentage. The user can specify a percentage split to configure the desired behavior.

Assume one wants a deployment (of 20 replicas) to be divided across three workload clusters and with a percentage split of 50%, 30% and 20% in the Schedule Policy. In this example, the workload clusters will run 10, 6 and 4 replicas each.

Overrides Per Cluster: This feature within spread scheduling allows users to override a subset of fields in a Kubernetes resource for each target cluster selected by a Spread Schedule Policy. This is useful in the case of a Kubernetes object that needs to be almost the same in each workload cluster, but needs one or more fields to be customized for each cluster.

As an example, if the user needs to apply a service-mesh label on the Namespace object describing the network and the value of this label has to be different for each cluster, then this overriding existing per-cluster labeling can be used to achieve this. It is possible to add these overrides in both Divide and Duplicate mode.

Below is an example spread policy that illustrates the divide mode in which replicas of a deployment will be split 20%-80% across two clusters named workload-1 and workload-2.

Snippet 6: Policy for spread scheduling.

```
Unset
spec:
  namespaceSelector:
      matchLabels:
          kubernetes.io/metadata.name: default
groupBy:
  labelKey: app
spreadConstraints:
  topologyKey: kubernetes.io/metadata.name
  percentageSplit:
    - topologyValue: kind-workload-1
  percentage: 20
    - topologyValue: kind-workload-2
  percentage: 80
clusterSelector:
  matchExpressions:
    - key: kubernetes.io/metadata.name
    operator: In
  values:
    - kind-workload-1
    - kind-workload-2
resourceSelectors:
  labelSelectors:
      - matchLabels:
        group-policy: nginx-spread
```

### Fill and Spill Scheduling

Fill and spill scheduling is a placement strategy in Nova that allows users to specify a list of ordered workload clusters to be used as potential candidates for an incoming workload. The order of clusters specifies the priority in which clusters should be considered for placement. This scheduling strategy is useful for AI/ML and GenAI workloads where preference is given to clusters that have 1) static resource availability and a 2) sunk-cost associated with them. The second-level of priority is given to cloud clusters where specialized resources (such as GPUs) can be scarce as well as expensive. One example of an implementation of this policy is as follows:

orderedClusterSelector:
matchExpressions:
   key: kubernetes.io/metadata.name
   operator: In
   values:
      onprem-workload-cluster
      eks-workload-cluster.

In the example snippet above, the field “OrderedClusterSelector” captures a fill-and-spill policy, that will first *fill* incoming workloads in the on-prem cluster named “on-prem-workload-cluster”. Once this cluster's capacity is full, subsequent workloads will then be placed on a cloud cluster, named “eks-workload-cluster”.

### Backpropagation

A Backpropagation feature may be included in Nova to improve visibility and control over workload clusters by reflecting objects created within these clusters back to the control plane 110. This feature is particularly useful for maintaining a unified view of all workloads, irrespective of the cluster they are deployed in. When an object, such as a Deployment, is created in the control plane 110, it is scheduled onto one or multiple workload clusters based on user-defined SchedulePolicies. The workload clusters, upon recognizing the Deployment, create associated objects like ReplicaSets, Pods, etc.

### Schedule Policy

A detailed example of a Schedule Policy is provided below with inline comments on what each section and field represents.

Snippet 6: Full example of SchedulePolicy:

```
apiVersion: policy.elotl.co/v1alpha1
kind: SchedulePolicy
metadata:
name: demo-policy
spec:
# namespace selector specifies namespace(s) where the matching resources are
# non-namespaced objects are matched as well.
namespaceSelector:
  matchLabels:
    kubernetes.io/metadata.name: microsvc-demo
  matchExpressions:
    - key: kubernetes.io/metadata.name
      operator: NotIn # possible operators: In, NotIn, Exists, DoesNotExist
      values:
        - namespace-2
        - namespace-3
        - namespace-4
# cluster selector specifies the list of workload clusters (represented as Cluster Custom
Resource)
# which will be considered as a hosting cluster for all resources matched by this policy.
# If more than one cluster is selected, Nova will try to pick a workload cluster which has
enough resources
# to host object (or objects grouped into ScheduleGroup).
# If clusterSelector is not specified, Nova will consider all workload clusters.
clusterSelector:
  matchLabels:
    nova.elotl.co/cluster.region: “us-east-1”
  matchExpressions:
    - key: kubernetes.io/metadata.name
      operator: NotIn
      values:
      - kind-workload-2
      - kind-workload-3
      - kind-workload-4
# groupBy.labelKey specifies how the objects should be grouped.
# If labelKey is empty (default), Nova won't group objects into ScheduleGroup and will
# try to find a workload cluster for each object separately.
# If you specify groupBy.labelKey, Nova will create ScheduleGroups for each value of
this label.
# This is convenient if you want to schedule multiple objects together (to the same
workload cluster).
groupBy:
  labelKey: color
# spreadConstraints enables spreading a group of objects (.spec.groupBy has to be
set) onto multiple clusters.
# spreadConstraints.topologyKey refers to the Cluster CR label which should be used
to group
# clusters into the topology domain. E.g. for topologyKey: nova.elotl.co/cluster.version
# clusters with nova.elotl.co/cluster.version=v1.22 will be treated as one topology
domain.
# For kubernetes.io/metadata.name each cluster will be treated as one topology
domain.
# percentageSplit defines spread constraints over the topology domain.
# Example below says:
# For all k8s resources with replicas matched by this policy (e.g. Deployment,
ReplicaSet),
# take a list of workloads clusters matching this policy (see .clusterSelector),
# then, for cluster having kubernetes.io/metadata.name=kind-workload-1 label create a
copy of k8s resources from this group
# and modify pod controllers' (Deployment, ReplicaSet, etc.) replicas to 20% of original
replicas number.
# For cluster having kubernetes.io/metadata.name=kind-workload-2 label create a copy
of k8s resources from this group
# and modify pod controllers' (Deployment, ReplicaSet, etc.) replicas to 80% of original
replicas number.
spreadConstraints:
  # available spreadModes are Divide and Duplicate
  # Divide gets the number of replicas for Deployments, ReplicaSets, StatefulSets, etc.
or parallelism for Jobs
  # and divides them between chosen clusters. In Divide mode it is guaranteed to run
exactly the number of replicas
  # that is specified in manifests.
  # In Duplicate mode, each workload clusters will run the original specified replica
count.
  # It means that if your Deployment has .spec.replicas set to 2 and the policy matches
3 workload clusters,
  # each workload cluster will run 2 replicas, so you will end up running 6 replicas in
total.
  spreadMode: Divide
  topologyKey: kubernetes.io/metadata.name
  # percentageSplit is ignored for spreadMode: Duplicate. Sum of
.percentageSplit.percentage values has to equal 100.
  percentageSplit:
    - topologyValue: kind-workload-1
      percentage: 20
    - topologyValue: kind-workload-2
      percentage: 80
  # You can use Overrides to configure customization of the particular objects managed
by this policy, per each cluster.
  # This is useful for cases when e.g. you want to have almost exactly the same
namespace in each cluster - but each one has a different label key,
  # or you need to spread a StatefulSet / Deployment across clusters and in each
cluster you need to set up unique identifier as a e.g. command line argument.
  # Here is an example how overrides can be used to create a same namespace in all
clusters but each labeled with different istio network annotation.
  # Original object need to have this label key set, with a placeholder value.
  overrides:
    - topologyValue: kind-workload-1
      resources:
        - kind: Namespace
          apiVersion: v1
          name: nginx-spread-3
          override:
            - fieldPath: metadata.labels[‘topology.istio.io/network’]
              value:
                staticValue: network-1
    - topologyValue: kind-workload-2
      resources:
        - kind: Namespace
          apiVersion: v1
          name: nginx-spread-3
          override:
            - fieldPath: metadata.labels[‘topology.istio.io/network’]
              value:
                staticValue: network-2
# resourceSelectors specify which resources match this policy.
# Using example below means
resourceSelectors:
  labelSelectors:
    - matchLabels:
        microServicesDemo: “yes”
      matchExpressions:
      - key: app.kubernetes.io
        operator: Exists
        values: [ ]
```

This SchedulePolicy will match all Kubernetes objects with label microServicesDemo: “yes” and app.kubernetes.io (regardless of label value) in the namespace microsvc-demo
match all non-namespaced objects with label microServicesDemo: “yes” and app.kubernetes.io (regardless of label value).
Then, objects are grouped into N groups based on each object's value of the label color (specified in.groupBy.labelKey).
Then, for each ScheduleGroup (e.g. group of all matched objects having color: blue label) Nova will try to pick a workload cluster, following guidelines specified in.spec.clusterSelector:
   For all Cluster(s) having nova.elotl.co/cluster.region=us-east-1 label, and not being named kind-workload-2, kind-workload-3 or kind-workload-4 Nova will check if a sum of resources (CPU, memory, GPU) required by objects in the ScheduleGroup is smaller than available resources in the Clusters selected. If there is such cluster, Nova will pick this workload cluster for this ScheduleGroup.

### Just-In-Time (JIT) Compute Clusters.

Nova has the capability to optionally put an idle workload cluster into standby state, to reduce resource costs in the cloud. When a standby workload cluster is needed to satisfy a Nova policy- or capacity-based scheduling operation, Nova brings the cluster out of standby state. Nova can also optionally create additional cloud clusters, cloned from existing workload clusters, to satisfy the needs of policy-based or capacity-based scheduling.

In “suspend/resume” standby mode (default), Nova sets all node groups/pools in a cluster in standby state to node count 0. This setting change causes removal of all cloud cluster resources, except those in the hidden cloud provider control plane. When the cluster exits standby, Nova sets the node group/pool node counts back to their original values, which it had recorded in the cluster's custom resource object. This setting change causes the restoration of the cloud cluster resources.

In “delete/recreate” standby mode (optional alternative to suspend/resume mode), Nova completely deletes a workload cluster in standby state from the cloud. When the cluster exits standby, Nova recreates the cluster in the cloud, and redeploys the Nova agent objects.

When the “create” option is enabled, Nova creates a workload cluster via cloning an existing accessible (i.e., ready or can become ready via exit standby) cluster to satisfy the needs of policy-based or capacity-based scheduling. Cluster creation depends on the Nova deployment containing a cluster appropriate for cloning, i.e., there is an existing accessible cluster that satisfies the scheduling policy constraints and resource capacity needs of the placement, but mismatches either the policy's specified cluster name or the placement's needed resource availability. The “create” option requires that “delete/recreate” standby mode be enabled. Created clusters can subsequently enter standby state. The number of clusters that Nova will create has a configurable limit. Note that Nova with the “create” option enabled will not choose to create a cluster to satisfy resource availability if it detects any existing accessible candidate target clusters have cluster autoscaling enabled. Instead Nova will choose placement on an accessible autoscaled cluster. Nova's cluster autoscaling detection works for installations of Elotl Luna and of the Kubernetes Cluster Autoscaler.

### System Implementation

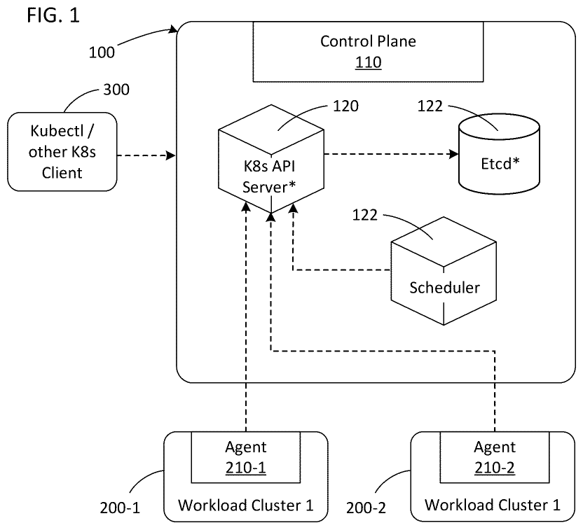

An embodiment of the internal architecture of the Nova system is illustrated in FIG. 1. In FIG. 1, two components are labeled with stars “*” to indicate that they are known, open-source components. These are a Kubernetes (K8s) API server 120 and a standard etcd component 130. As is known, the etcd (derived from the Unix “/etc” folder and the “d” in “distributed) component is an open source, distributed key-value store used to hold and manage important information that distributed systems need to keep running; in particular, the etcd component 130 is included to manage configuration data, state data, and metadata within the Kubernetes platform.

Two main components provided and used by the invention are a control plane 110, installed on a hosting cluster 100, and agents 210-1, 210-2 (referenced generally as 210), installed on workload clusters 200-1, 200-2 (referenced generally as 200). In the figure, only two workload clusters are illustrated, but there may in actual implementations be any number of them. As FIG. 1 illustrates as “box” 300, the known Kubernetes command line tool Kubectl for communicating with a Kubernetes cluster's control plane, using the Kubernetes API, as well as other clients may also communicate with the hosting cluster 100.

### Nova Scheduler 122

A scheduler component 122 performs the key functionality to place workloads on target workloads clusters. In one embodiment, it is implemented as a set of controllers that run a reconciliation loop to ensure that all Kubernetes workloads matching user-defined SchedulePolicies are in fact scheduled to the correct workload clusters.

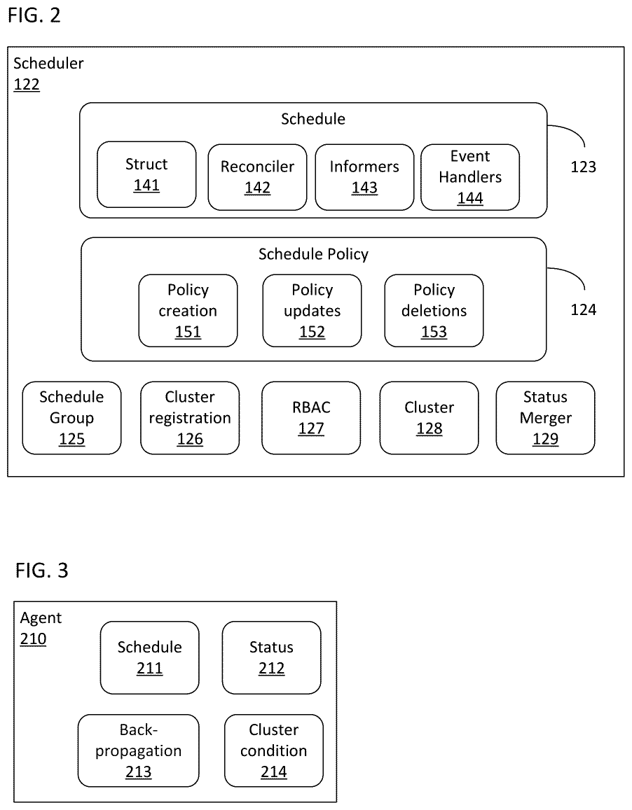

In one prototype, the scheduler 122 included seven controllers (see FIG. 2), although, in other implementations, more or fewer could be included, depending on specific needs. Moreover, although these controllers are described as separate software components, in actual implementations they may be embodied either as separate bodies of computer-executable code that is stored in any conventional medium and executed on one or more processors, or any or all of them could be combined into single code sets. The seven controllers in this embodiment (see FIG. 2) are:
Schedule Controller 123
Schedule Policy Controller 124
Schedule Group controller 125
Cluster registration controller 126
Role Based Access Control (RBAC) Controller 127
Cluster Controller 128
Status Merger Controller 129

These are individually described in greater detail below.

### Schedule Controller 123

The Schedule controller 123 is responsible for matching a workload with a Schedule Policy. It also assigns workloads to the correct Schedule Group (if the matched policy is a group policy) and schedules workloads to the appropriate workload cluster.

For a workload that uses Annotation Based Scheduling, it will create a Schedule ConfigMap in a given target workload cluster namespace. For other workloads that are going to be placed using Schedule Policies, it will either: Try to assign a workload to a ScheduleGroup (if matched policy is a group policy); or it will find a target workload cluster and create a Schedule object for it. The workload-to-Schedule Policy match is captured by the Schedule object which is a ConfigMap. The Schedule ConfigMap stores details of: a) the Workload (Group, Version, Kind, Name, Namespace, Manifest as JSON, Manifest hash), and b) the matching SchedulePolicy (Policy name and ID)

The core components of the Schedule Controller 123 include:
Scheduler struct 141: This is the main Go data structure in a scheduler.go file, which holds clients (Client, DynamicClient), the ScheduleReconciler, event handlers, event recorders, Informers and other configuration needed for the scheduler.
ScheduleReconciler 142: The ScheduleReconciler is a component responsible for managing the scheduling logic in the Scheduler. When the Scheduler needs to place an object, it delegates the actual placement (or any reconciliations required) to the ScheduleReconciler.
Dynamic Informers 143: Dynamic informers watch and react to changes to instances of a specific resource type in the cluster. In the Scheduler, the resource of interest is the Custom Resource “SchedulePolicy”.
Event Handlers 144: Event handlers enable handling of Kubernetes events to schedule resources or remove them when no longer needed. The EventHandler defines steps that will be invoked in response to lifecycle events: add, update, delete for the watched resources, which in this case are Schedule Policy and Schedule ConfigMap.

The Schedule Reconciler 142 performs these functions:

1. Matching Schedule Policy determination (Function name: GetPolicy): Among all available schedule policies, this function determines which policy matches a given Kubernetes object. A policy matches a given Kubernetes object based on the label selector and namespace selector specified in the Schedule Policy.

2. Target Cluster Determination (Function name: GetTarget): This function determines the target cluster for a given Kubernetes object. It uses annotation-based scheduling if the Kubernetes object has a predefined annotation such as “nova.elotl.co/cluster”. If it doesn't have this annotation, then the target cluster is determined based on the matched Schedule policy using the HandleMatchedPolicy function described next.

3. Processing Schedule Policy (Function Name: handleMatchedPolicy): Once the matching Schedule policy is determined for a Kubernetes object, we then process this matched policy. Processing this policy depends on whether:
Case 1) Policy is a group scheduling policy (aka Gang Scheduling)
Case 2) Policy includes all workload clusters connected to the Nova control plane or
Case 3) Policy includes only a subset of workload clusters connected to the Nova control plane. For Case 1)

Case 1: Processing group schedule policies is handled as follows (Function Name: handleGroupSchedulePolicy): This method will create or update a new ScheduleGroup into which this object needs to be added and then the group of objects will be scheduled as a unit
If the object-to-be-placed is already assigned to a ScheduleGroup, rescheduling of the group is triggered
If the object is not yet assigned to any Schedule Group then we find all existing Schedule Groups for this policy. In this list of ScheduleGroups if there is a group with the value of the grouping label in the object, then this object will be added to this existing group.
If there is no existing group whose label key matched the label key value in the object, then a new Schedule Group is created for the object.

Case 2: Processing schedule policies that include all workload clusters connected to Nova is handled as follows (Function Name: findClusterWithAvailableResources): This method will find one amongst all workload clusters that has sufficient resources (CPU, Memory and GPUs) to host/run this Kubernetes object/workload.

Case 3: Processing schedule policies that include only a subset of workload clusters connected to Nova is handled as follows (Function Name: findClusterWithAvailableResources): A subset of workload clusters is captured by a SchedulePolicy using the ClusterSelector and OrderedClusterSelector fields. The subset of clusters to be considered and the order in which these need to be considered is first determined (Function name: ListPossibleClusters) and then one amongst these is chosen based on sufficient resource (CPU, Memory, GPUs) availability.

### SchedulePolicy Controller 124

The SchedulePolicy controller is responsible for re-scheduling workloads when the cluster selection of a given policy changes. This controller also takes action when spread constraints in a Schedule policy changes. In the latter case, when spread constraints change in a given policy, this controller will first list all the ScheduleGroups for a given policy and mark them as not-scheduled. For a policy which does not use group scheduling, this controller will find all matching Schedules for this policy, then it will delete them from the old matching target cluster namespace and re-create them in the new matching target cluster namespace.

The SchedulePolicy 124 manages Schedule Policy custom resources and for the creation, deletion and update of Schedule ConfigMap objects. The PolicyController Go struct comprises Kubernetes clients to perform CRUD operations on objects running in the workload clusters. When this controller is started up, informers (see below) are set up to watch for SchedulePolicy and ConfigMap (aka Schedule) events. This controller includes three event handlers described below:

New policy creation 151: Policy creation does not trigger any action. This is because each newly added policy only affects Kubernetes objects created after policy creation.

Policy updates 152: When a SchedulePolicy is updated, two different methods handle processing depending on whether the policy is a group policy or not. The main action that gets triggered is a possible rescheduling of objects across workload clusters.
Handling Rescheduling for Group policies (Function Name: handleRescheduling ForPolicyWithGroupingEnabled): For the case of group policies, all the Schedule Groups managed by this policy are marked as “Unscheduled” (Function Name: markScheduleGroupAsNotScheduled) and then will be scheduled by subsequent reconciliation loops.
Handling Rescheduling for non-Group policies (Function Name: handle Rescheduling ForPolicyWithGroupingEnabled): In the case of non-group policies, we first determine the current target cluster (oldCluster) as specified in the old policy as well as the list of potential target clusters (newClusters) as specified in the updated policy. If the oldCluster is one among the newClusters, then no rescheduling is needed. If not, a rescheduling would need to be triggered for all objects that were placed on the oldCluster by the current policy. Each cluster has an associated namespace for it in the Nova control plane cluster. All the Schedule Config Maps in this namespace are checked to see which ones were placed by the current policy of interest. This matching is done using a field in the Schedule ConfigMap for each object called the “matching-policy-id”. Then the subset of objects in this cluster is rescheduled to one of the newClusters.

Policy deletions 153: When a policy is deleted all schedule groups associated with that policy are deleted. The actual objects scheduled by the policy-to-be-deleted will continue to remain on the workload clusters. User objects on workload clusters are deleted only if they are explicitly deleted by a user via a delete command to the Control plane. This ensures that no user resources are unintentionally deleted by a user.

The actual rescheduling of the Kubernetes resource from one cluster to another involves deleting the associated Schedule Config Map from the old cluster's namespace to the new target cluster's namespace within the Nova Control plane.

### Schedule Group Controller 125

The Schedule Group controller is responsible for scheduling an entire group of workloads *together* to the target cluster (or clusters, if the matched policy is a spread policy). Scheduling a group of workload is also referred to as “Gang scheduling” in the artificial intelligence/machine learning (AI/ML) domain. The controller reconciles the ScheduleGroup, then tries to match possible workload clusters using a “ClusterSelector” or “OrderedClusterSelector” from the ScheduleGroup's policy. There are several cases that are handled by this controller:
a. Cluster selector does not match any cluster. Then, the ScheduleGroup cannot be scheduled anywhere.
b. Cluster selector matches exactly one workload cluster. Then, the ScheduleGroup will be scheduled there.
c. Cluster selector matches multiple workload clusters.
   i. If it is a spread policy (i.e. when.spec.SpreadConstraints are defined), the controller will try to spread ScheduleGroup onto the multiple clusters according to defined constraints.
   ii. If it is a non-Spread policy (i.e. when.spec.SpreadConstraints are not included), this controller will pick one of the workload clusters. Helper functions will sum the CPU, memory and GPU resources requested by all objects in the Schedule Group and try to pick a cluster that has sufficient resources.

The ScheduleGroup controller 125 is also responsible for removing a workload from the current cluster that it is already placed on, after a rescheduling action has been triggered. This is implemented using a “schedulegroup.Scheduled” Boolean field.

A ScheduleGroupController Struct is the main data structure of this controller. This contains Clients (to manage objects on the workload clusters), Event recorders (used to log important event during scheduling operations), Metrics collectors (a custom metrics collector to track scheduling statistics), the Schedule reconciler (which helps the Schedule Controller make scheduling choices) and parameters for Just-in-Time capability, such as whether the feature is enabled in a specific deployment (ClusterCreationEnabled) and the maximum number of clusters that Nova-JIT is allowed to create (MaxCreatedClusters).

The controller's main operation is captured in a “Reconcile” routine that is invoked anytime a ScheduleGroup is created, updated or deleted. There are two conditions under which this Reconcile function takes action:
1. If the group is created, then an associated “Scheduled” field will be at its default Boolean value of False.
2. If the group was updated and its “Scheduled” field is set to False

Under both these conditions, the list of potential target clusters specified by the Schedule Group's corresponding policy is determined. Then, one among the following actions are taken:
a. If the corresponding policy of the ScheduleGroup is a spread policy, then determine how the workload will be spread onto the constituent clusters.
b. If the number of potential target clusters is one, then place the group on that cluster.
c. If the number of potential target clusters is greater than one, then place the group on whichever cluster has sufficient resources.

A key advantage of the Group or Gang scheduling capability is that new objects can be added to an existing Schedule Group after its initial creation time. The Nova system will then attempt to place the new object on the same cluster that the rest of the objects were placed on.

### Cluster Registration Controller 126

The Cluster registration controller is responsible for managing workload clusters that join the Control Plane. Each workload cluster is represented by an instance of a “Cluster” Custom Resource. This controller reacts to the creation and deletion of these “Cluster” custom resource objects.

The main data structure for this controller is a ClusterRegistrationController struct that encapsulates clients used to manage objects on the workload and control plane cluster as well an event recorder, which tracks important events managed by this controller.

This controller watches for “Cluster” (a Custom Resource) creation and deletion and acts as follows:

On cluster creation, the controller creates the following objects:
a) ServiceAccount—this is used by the agent in the workload cluster
b) Secret with the above ServiceAccount token
c) ClusterRoleBinding—that links the nova-agent ClusterRole to the newly created ServiceAccount.

These objects enable communication between the Control Plane 110 and the workload cluster 200. By creating a binding to the ClusterRole, it is ensured that the respective agent has least privilege access to Control Plane resources. These objects are created within a special namespace in the Control Plane 110 that is associated with each new workload cluster. This controller creates such a namespace if one does not already exist. On deletion of the Cluster Custom Resource, all the above listed objects are deleted from the Nova Control Plane.

### Role Based Access Control (RBAC) Controller 127

The RBAC controller manages RBAC resources needed for the initialization phase of the Nova agent deployment in a workload cluster. It ensures that the necessary roles, role bindings and service accounts are setup correctly to allow the Nova agent to communicate with the Nova CP initially.

The RBAC resources created by this controller include Roles, Cluster Roles, Role bindings, Cluster Role bindings, Service accounts and Secrets containing service account tokens. This controller also creates Configurations for Nova's mutating and validation webhooks and an Initial Kubeconfig

### Cluster Controller 128

The Cluster controller is responsible for creating the Cluster custom resource for Nova's JIT (Just-in-Time) capability and for managing the status of all workload clusters (irrespective of whether they were created by Nova JIT or directly connected to the Nova Control Plane 110) throughout their lifecycle within the Nova system.

The controller checks the state of all workload clusters and updates them periodically in the Cluster's Custom Resource status field. Under normal operating conditions a cluster is in “Ready” state. Workload clusters are marked in the “Not Ready” state in those cases when the most recent heart beat from the workload cluster's was received before a predefined interval. This controller is also configured to put the workload cluster into “Standby” mode when the Nova JIT feature is enabled. A cluster is said to be in “Standby” mode when all its node groups are scaled down to 0 worker nodes and only the control plane nodes are kept running.

The controller also periodically determines if clusters need to be scaled up or down based on the configured JIT policy. When a new cluster needs to be created, its properties are cloned from an existing cluster connected to the Nova control plane. The cloned cluster inherits details such as provider, region, zone, Kubernetes version, and node groups from the original cluster.

### Status Merger Controller 129

The Status Merger controller runs within the Nova scheduler pod and applies to all workloads that are deployed across multiple clusters using the Spread Scheduling policy. This controller is responsible for aggregating status from the Kubernetes object on multiple clusters into a single status of the same Kubernetes object in the Nova Control Plane. Nova agents running on workload clusters populate the individual per-cluster status Config Maps within a special namespace called, for example, the “elotl-nova-status-merges” on the Nova control plane. The Status merge controller reacts to all create, update and delete events to objects within this special namespace. Each object in the workload cluster managed by a spread scheduling policy updates its status by creating a special ConfigMap (called the Status ConfigMap) in the Nova Control Plane 110. This controller determines all the Status ConfigMaps for a given workload and aggregates them into a single status. The last step is updating the corresponding workload in the Nova Control Plane with the calculated status. Nova currently supports status aggregation for Deployments, StatefulSets, ReplicaSets and Jobs. Aggregated status calculation includes summing up the number of replicas from all workload clusters, as well as combining workload conditions into a list of conditions.

### Nova Agent 210

The agent 210 is a component that operates within a workload cluster 200. It functions as a Kubernetes controller and is responsible for local resource scheduling. It continuously watches for changes in schedule objects within the control plane 110. When a new change is detected, the agent applies these changes to the local cluster. The agent is also locally schedules resources in its respective workload cluster. These scheduling decisions are based on instructions from the scheduler 122. The agent also updates cluster state to the control plane 110. If back propagation is enabled, it is responsible for synchronization of state between the workload cluster and the control plane 110.

See FIG. 3. An agent 210 runs four controllers: a schedule controller 211 that is watching for resource changes in the control plane 110 and applying them in the workload cluster; a status controller 212 and backpropagation controller(s) 213 that are watching for changes of resources in the workload cluster and applying them in the control plane 110, and a cluster condition controller 214 that periodically updates the status of the corresponding cluster custom resource in the control plane 110.

### Agent Schedule Controller 211

This controller watches for creation, updates and deletion of the “Schedule ConfigMap” in the namespace corresponding to its workload cluster in the Nova Control Plane. Its main responsibility is making sure that the object's specification, defined in the Schedule ConfigMap is applied to the workload cluster. Similarly, on deletion of the Schedule Config Map in the Nova Control Plane, this controller deletes the resource in the workload cluster. The agent schedule controller thus interacts with both the Nova control plane and the workload cluster to manage the key aspects of the lifecycle of Kubernetes workloads.

Workload creation and updates: In the reconciliation loop of this controller, the Schedule ConfigMaps in the Control Plane 110 are read using a control plane Kubernetes client. This Config Map will contain the manifest of the object to be placed. This manifest is decoded and applied to the local workload cluster. After successfully applying the workload to the workload cluster, a status controller is created for the workload's type (where type is specified as a Group Version Kind). Any updates to a workload object already running on the local cluster may also be determined and applied by this controller: Before creating a workload, the controller checks if the workload already exists. If it does, then the workload is updated using a cluster client. In the case of workloads of the kind “Job”, only labels and annotations are allowed to be changed, in order to prevent conflicts with the native-kubernetes job controller in each cluster. After workload creation or update, the status of the workload in the Schedule ConfigMap is updated to “applied” and the Schedule Finalizer is also added to it.

Workload deletion: During reconciliation, if the Schedule ConfigMap is marked for deletion, the controller deletes the corresponding workload from the local cluster. The finalizer is removed from the Schedule config map. Once the finalizer is removed, the Control plane will, in turn delete the Schedule object. During deletion, any orphaned resource such as pods associated with Jobs are also deleted. Label selectors are used to find and delete these pods.

### Status Controller(s) 212

Each of these is responsible for syncing the status of the given object. It updates the status of control plane 110 objects, based on the status of the same object in the workload cluster. Nova may run multiple status controllers, one per each Kind of object (e.g. Deployment, Service, etc.). This controller is also responsible for detecting when an object cannot be scheduled, because there are not enough compute resources (vCPU, memory). In this situation, this controller triggers rescheduling of ScheduleGroup containing unscheduled objects. This controller also handles change of status for objects which were spread-scheduled across multiple workload clusters—for these, it does not update the status of objects directly in the control plane 110, but creates a ConfigMap containing the workload cluster's object status. These are then aggregated by the status merger controller, which runs as a part of Nova scheduler (see Nova scheduler section).

### Backpropagation Controller 213 (Optional)

If enabled, it syncs “child” objects (such as Pods for ReplicaSets, ReplicaSets for Deployment, etc.) from the workload cluster to the control plane 110. This controller watches for resources which have an Owner Reference set, then checks if the Owner resource was scheduled by Nova to the workload cluster. In this case, it creates the child resource in the control plane 110.

### Controllers Watching for Resources in the Control Plane 110 are:

Schedule Controller 211—watches for creation, updates and deletion of Schedule ConfigMap in the namespace corresponding to the workload cluster in the control plane 110. Its main responsibility is making sure that an object's spec, defined in the Schedule Config Map, is applied in the workload cluster. On deletion of the Schedule Config Map in the control plane 110, Schedule Controller deletes the resource in the workload cluster.

Cluster Condition Controller 214—updates corresponding Cluster CR (custom resource) in the control plane 110. It periodically updates the heartbeat, readiness condition, Kubernetes version as well as available compute resources (vCPU, memory and GPU) and node taints. Compute resources and node taints set in the Cluster CR status are used by Nova scheduler to make informed decisions before placing a group of resources in this workload cluster.

### Backpropagation

The Backpropagation feature in Nova is implemented as a Kubernetes controller 213 within the agent 210 running in each workload cluster 200. It synchronizes workload-related objects from workload clusters back to the control plane 110. This ensures a unified view and control over all workloads, irrespective of the cluster they are deployed in.

The Backpropagation feature works by monitoring these additional objects created in the workload clusters 200 and reflecting them back to the control plane 110.

This is achieved through a series of steps:
Monitoring: Nova's agents 210 within the workload clusters 200 monitor the creation of new objects such as ReplicaSets and Pods.
Labeling: Each object created within the respective workload cluster is labeled with a unique identifier, such as nova.elotl.co/backpropagated.origin, to indicate its origin.
Data Transmission: The labeled objects are then transmitted back to the control plane 110.
Unified View: The control plane 110 aggregates these objects, providing a unified view and control interface for the user.

### Operation of the Backpropagation Controller 213

Initialization of the Controller: In the agent main function Nova initializes the BackPropagationController and add it to the workload cluster's controller manager
Monitoring of Object Events: Nova uses Kubernetes Informers, that is, client-side libraries that provide a mechanism to watch and react to changes in resources to monitor object events, (Add, Update, Delete) in the workload cluster.
Checking Object Ownership: After each of the add, update or delete events, Nova first checks if the object owner is managed by recursively checking the owner of this object for a label that indicates that it was scheduled through Nova. It thus handles objects that were created only as a result of objects scheduled through control plane 110 and Nova does not need to replicate any local/internal workloads of those clusters.
Object preparation for Backpropagation: If the object is managed by Nova, it prepares it for backpropagation by clearing certain fields and setting the appropriate labels.
Reflect Object to control plane 110:
   Object Add event: In this case, a new object is created in the control plane 110 if it doesn't already exist.
   Object Update event: In this case, an existing object is patched in the control plane 110 with the updated fields.
   Object Delete event: In this case, the object is deleted from the control plane 110.
Mark Object as Propagated: After successfully reflecting the object to the control plane 110, Nova marks it as propagated in the workload cluster by adding a label to it. This would prevent it from being back-propagated again to the Nova control plane.

### Just-In-Time Compute Clusters

The Nova control plane handles and tracks all K8s objects it places on its workload clusters. It characterizes a workload cluster as idle if it sees that there are currently no active-usage K8s objects it placed on that cluster. Active-usage K8s object kinds are pods, jobs, services, deployments, cronjobs, replicasets, and stateful sets. Once the workload cluster has been idle for a configurable time, the Nova control plane automatically places the workload cluster into standby state.

The Nova control plane inputs regular updates on the current available capacity of its active workload clusters and on whether those clusters are running the Elotl Luna or Kubernetes cluster autoscaler. The Nova control plane also retains a record of the capacity of the standby workload clusters.

When the Nova control plane is handling placing a K8s object that is subject to capacity-based scheduling, and it finds that no non-standby clusters have sufficient available capacity for the K8s object's resource configuration and none are running a cluster autoscaler, the Nova control plane checks if any standby cluster can satisfy the object's resource needs. If so, it brings the cluster out of standby to allow object placement. If no standby cluster has adequate resources and the “create” option is enabled, Nova checks if any non-standby cluster would have sufficient available capacity if it were empty, and if so, the Nova control plane clones that cluster to allow object placement.

When the Nova control plane is handling placing a K8s object that is subject to policy-based scheduling, and it finds no non-standby cluster that satisfies the policy, it checks if any standby cluster satisfies the policy. If it does, the Nova control plane brings that cluster out of standby. If no standby cluster satisfies the policy and the “create” option is enabled, Nova checks if any cluster can be cloned and modified to match the policy (by modifying the clone target cluster name) and if so, the Nova control plane clones that cluster to allow object placement.

### Automation of HA/DR

This Nova feature enables automatic handling of failures and thereby provides zero-touch high-availability (HA) and disaster-recovery (DR) to Kubernetes stateful workloads. Nova has a webhook endpoint (a URL that receives webhook event notifications and can trigger an action based on the payload sent in the message) on the control plane that will accept initiation of the failover and remediation actions. A Kubernetes monitoring solution such as Prometheus may be used to trigger these failover actions through alerts. These alerts are generated by the cluster monitoring solution under a variety of user-defined conditions such as application metrics exceeding a threshold, cluster-level health metrics indicating failures and performance degradations, etc.

Failover and remediation actions include two categories: a) Modification of stateful workload parameters—for example, conversion of the standby database to primary, and (b) Modification to external cloud resources—for example, redirection of end-user traffic by a load-balancer to the new primary. These actions are captured either as a Kubernetes job (see https://kubernetes.io/docs/concepts/workloads/controllers/job/) or as container images specified by the application's HA/DR developer.

In the description above of the various features of different embodiments of the invention, names are given for such things as system components, parameters, routines, functions, variables, etc., in both code snippets and in general. These are the names that were used in different prototypes of the invention but are of course not required to be used in any other implementations; system designers will of course be able to choose their own names for any or all of these.

The invention operates in the context of Kubernetes clusters and, as such, the components of the invention shown in the figures and described above may, and, in most cases, will be, running on a plurality of computing platforms, such as servers. Workload clusters 200 and their installed agents 210, for example, will typically be associated with respective clients and will therefore typically also be running on difference platforms. Moreover, by definition, a Kubernetes cluster may involve more than one node, and thus more than one computing platform, although this is not a an absolute requirement. Each computing platform will, as usual, include at least one processor, system software, and storage devices, which may be volatile and/or non-volatile

As such, the various components of the invention, for example, the software components shown in FIGS. 2 and 3, may be executed on separate computing platforms. Each of those components, however, will be implemented as a respective (or combined) body of computer-executable code that is embodied in the storage devices and that, when executed by the processor(s), causes the processors to carry out the functions described above for the corresponding software components.

1. A method for managing execution of computing workloads by a fleet of multiple Kubernetes clusters in a distributed computing environment comprising:
determining on which of a plurality of managed clusters to place the workloads by tracking and matching resource needs of the respective workloads with resource capacities and availability of at least selected ones of all of the fleet of clusters;
duplicating common Kubernetes workloads related to multi-tenancy across subsets of the fleet of clusters;
placing the workloads on one of: an ordered set of target clusters and, according to the ordered set, prioritizing the workloads in the ordered set, and statically, pre-determined clusters;
cloning and, on-demand, bringing up new clusters and shutting down shut down idle clusters; and
triggering start of workloads from a failed cluster to a different functional cluster.
